(19) United States
(12) Patent Application Publication
(10) Pub. No.: US 2006/0294143 A1
(43) Pub. Date: Dec. 28, 2006

(54) Method for capturing and browsing image data synchronously

(75) Inventors: Chih-Chuan Cheng, Taipei (TW); Hong-Tien Wang, Taipei (TW); Wen-Sung Tsai, Taipei (TW); Tsai-Chung Wang, Taipei (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: Compal Electronics, Inc.

(21) Appl. No.: 11/320,940

(22) Filed: Dec. 30, 2005

(30) Foreign Application Priority Data
Jun. 27, 2005 (TW) 094121390

(51) Int. Cl. G06F 7/00

(52) U.S. Cl. 707/104.1

(57) ABSTRACT

The present invention relates to a method for capturing and browsing image data synchronously, by the method, a user can browse all image data when he/she captures image data, so as to help him/her early to find bad captured image data and recapture the image data, which comprises the steps of: providing a portable device, which comprises an image capture device, a display screen and a controller; using the image capture device to capture a plurality of image data and storing them in the portable device when the portable device is operated in an image capture mode; the controller receiving a browsing triggering signal; and the controller executing a program triggered by the browsing triggering signal to play the image data on the display screen in sequence.

### BACKGROUND OF THE INVENTION

1. Field of the Invention

The present invention relates to a method for capturing and browsing image data synchronously, and more particularly to a method for capturing and browsing image data synchronously, when a portable device is operated in an image capture mode.

2. Description of the Related Art

In general, a prior art image capture device such as a digital camera captures an image and browses the image by the following steps: 1. Capture an image data by shooting a picture under the image capture mode, and the picture taken will be previewed on a display of a screen for a few seconds before the picture disappears. 2. Switch the digital camera to a browsing mode and select the desired browsing pictures. We found that the prior art image capture device at least has the following shortcomings: 1. A user who uses this indirect browsing method has to switch between the picture mode and the browsing mode, and thus the prior art image capture device is inconvenient for the user to use. 2. A user can only browse one picture at a time in the picture mode and such design is not friendly. 3. If a user shoots a slide show, the user cannot know about the effect of the slide show while shooting the dynamic pictures. As a result, the effect of the slide show is not good and it is necessary to shoot the slides again.

R.O.C. Pat. Publication No. 571520 entitled “Self-constructed multipurpose modular portable device and its construction method” (filed on May 17, 2002 and published on Jan. 11, 2004) relates to a portable device capable of self constructing multipurpose modules, and the portable device comprises: a transceiver for performing a wireless communication with a consumer's device; at least one connecting point for connecting at least one module component; and a processor for configuring the portable device and the module component according to the communication result received by the consumer's device, and includes a browser application program for carrying out a wireless communication between the portable device and an intellectual device. Such patent is primarily designed for a portable device situated without a predetermined range, and the portable device can communicate with the consumer's device. However, such patent does not have an image capture device or the function of browsing the captured images in the image capture mode.

### SUMMARY OF THE INVENTION

The primary objective of the present invention is to provide a method for capturing and browsing image data synchronously, and the portable device in an image capture mode can capture and browse image synchronously. It is not necessary to switch to the browsing mode to take pictures while browsing the pictures and improve the convenience of the application.

Another objective of the present invention is to provide a method for capturing and browsing image data synchronously that a user can shoot a slide show while browsing the image data directly in the image capture mode. Therefore, users can immediately know about the dynamic effect of the slides taken.

A further objective of the present invention is to provide a method for capturing and browsing image data synchronously that a user can browse several image data at a time. It is not necessary to select the pictures one by one for the browsing, which makes the operation of the machine simpler and easier.

To achieve the foregoing objects, the method for capturing and browsing image data synchronously in accordance with the present invention comprises the steps of: providing a portable device, and the portable device includes an image capture device, a display screen, and a controller; the portable device at an image capture mode capturing a plurality of image data by the image capture device and saving the image data in the portable device; the controller receiving a browsing triggering signal; the browsing triggering signal triggering the controller to execute a program, and the program playing the plurality of image data in sequence on the display screen.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

FIG. 1 is a schematic block diagram of a portable device produced by using a method according to a preferred embodiment of the present invention; and

FIG. 2 is a flow chart of the method for capturing and browsing image data synchronously according to a preferred embodiment of the present invention.

### DETAILED DESCRIPTION OF THE PREFERRED EMBODIMENTS

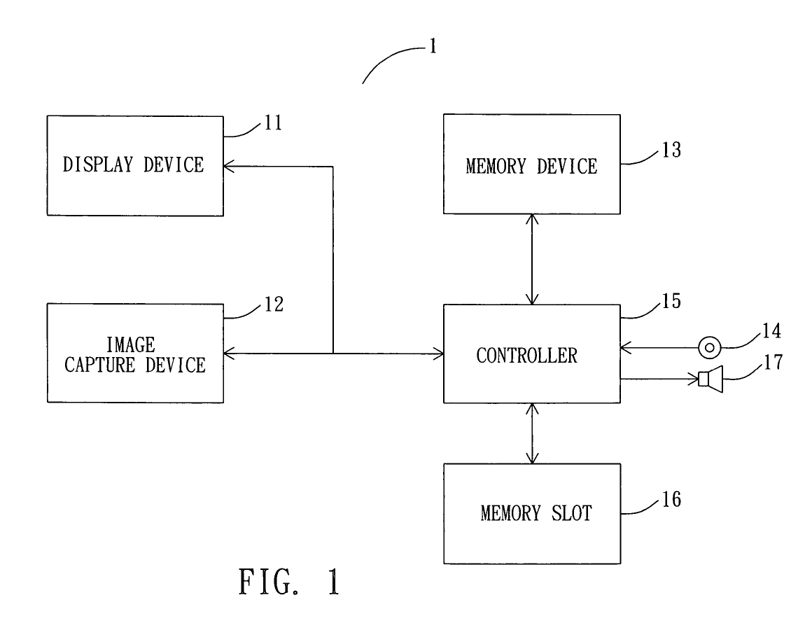

Referring to FIG. 1 for the schematic block diagram of a portable device produced by using a method according to a preferred embodiment of the present invention, the portable device 1 of the invention is preferably a digital camera and comprises a display device 11, an image capture device 12, a memory device 13, a slide show key 14, and a controller 15.

The display device 11 is but not limited to a liquid crystal display (LCD) for displaying data, wherein the display device 11 can further divide its screen into a picture-in-picture screen if needed, so that a user can view the pictures taken on the display device 11 while taking the pictures. Of course, a user can also view the desired picture from the viewing window, but the user generally decides whether or not to take a particular picture by viewing the screen of the display device 11. The image capture device 12 is but not limited to a CCD image module, a CMOS image module, or a digital camera module coupled to the display device 11 for capturing an image data and display the image data on the display device 11.

The memory device 13 is but not limited to a flash memory for temporarily saving the image data, and the slide show key 14 is coupled to the controller 15, so that if the portable device 1 is set to the image capture mode and the slide show key 14 is pressed to produce a browsing triggering signal to the controller 15, then the controller 15 will execute a program to display all image data stored in the memory device 13 in sequence or in random on the display device 11. Further, the browsing triggering signal can further set the number of times of browsing the image data or the user terminates the browsing. If the number of times of browsing set by the browsing triggering signal is reached, or the browsing is terminated by the user, the portable device 1 will stop playing the image data.

In the present invention, the controller 15 is the core of the portable device 1 and the controller 5 is coupled to the display device 11, the image capture device 12, the memory device 13, and the slide show key 14. The controller 15 includes a program (not shown in the figure) for controlling the operation of the portable device 1, so that when the slide show key 14 is pressed, the slide show key 14 will send the browsing triggering signal to the controller 15, and the controller 15 will execute the program and play the image data stored in the memory device 13 in sequence or in random on the display device 11 to complete the slide show purpose.

To increase the memory capacity, the present invention further includes a memory slot 16 coupled to the controller 15 for inserting at least one memory card (not shown in the figure), wherein the memory card includes but not limited to a SmartMedia, a CompactFlash, a MMC, a Security Digital (SD), a Memory Stick, a Memory Stick Pro, a Xd or a Microdrive memory card. Since these memory cards are prior arts and thus will not be described here.

Further, the portable device 1 of the invention further comprises a sound output device 17 including but not limited to a loudspeaker or an earpiece socket coupled to the controller 15. The controller 15 plays the image data while selecting the music, so that the sound output device 17 outputs the selected music as background music/song. If the number of times of the browsing set by the browsing triggering signal is not reached or a user has not given a command to terminate the browsing, the slide show key 14 will continuously send out the browsing triggering signal, and the image capture device 12 will continuously send out the stored image data, and the sound output device 17 also will keep playing the background music/song.

The operation of the portable device according to the method for capturing and browsing image data synchronously of the present invention is described as follows. A user switches the portable device 1 to an image capture mode. The user uses the image capture device 12 to capture a plurality of image data and save the image data in the memory device 13. The user presses a slide show key 14 to produce a browsing triggering signal to the controller 15. The controller 15 executes the program to play the plurality of image data stored in the memory device 13 on the display device 11, so that the user can directly carry out a slide show under the image capture mode. It is not necessary to switch to the picture mode. If the user shoots a slide show, the user can browse the image data directly under the image capture mode and know about the dynamic effect of the slide show while shooting the slide show, which makes the operation of the portable device 1 of the present invention simpler and easier. While the controller 15 is playing the image data, the user can use the image capture device 12 to continue capturing the image data. The program will add the new captured image data in the playing sequence and display the new captured image data on the display device 11. Now, the picture-in picture screen of the display device 11 will show the captured screen (not shown in the figure) of the shot taken by the image capture device 12, and another sub-screen will show the image data stored in the memory device 13, so that the user can take pictures while browsing the picture without the need of switching the operating mode of the portable device 1.

With the foregoing structure, the portable device 1 of the present invention shows the image data captured by the image capture device 12 on the display device 11 without the need of switching the operating mode. The present invention can surely overcome the shortcomings of the prior art portable device having the function of an image capture device.

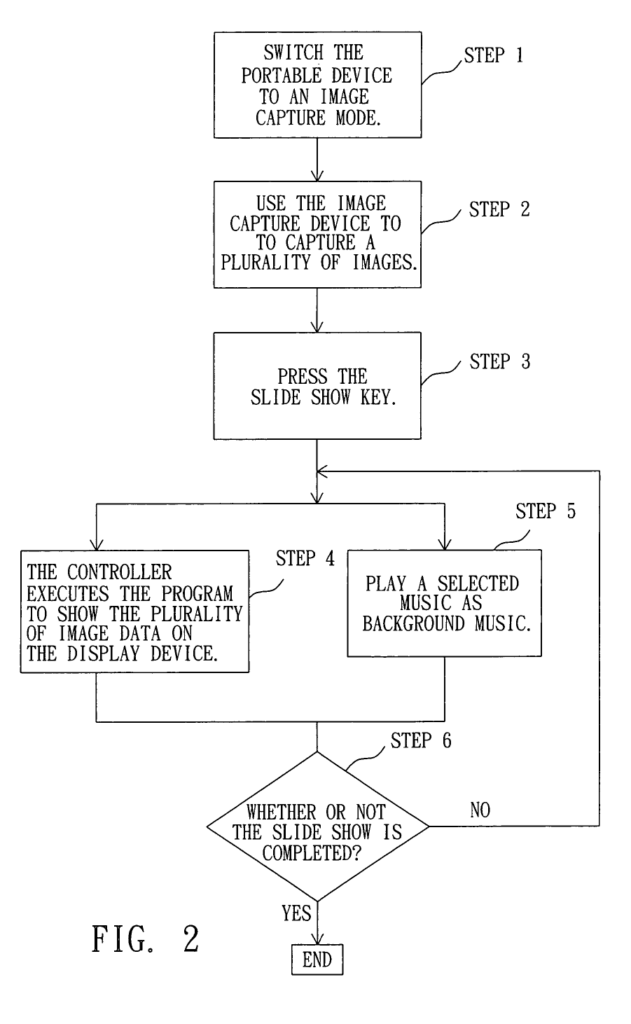

Referring to FIG. 2 for the flow chart of the method for capturing and browsing image data synchronously according to a preferred embodiment of the present invention, the method is applied to a portable device 1, and the portable device 1 comprises a display device 11, an image capture device 12, a slide show key 14, and a controller 15, and the controller 15 includes a program (not shown in the figure), wherein the display device 11 is but not limited to a liquid crystal display (LCD) and further comprises a picture-in-picture screen, and the image capture device 12 is but not limited to a CCD image capture module, a CMOS image capture module, or a digital camera module. The method comprises the following steps: Switch the portable device 1 to an image capture mode (Step 1). Use the image capture device 12 to capture a plurality of image data, and save the image data in a memory device 13 (Step 2). Press the slide show key 14 to produce a browsing triggering signal to the image capture device 12 (Step 3). Finally, the controller 15 executes the program to display the plurality of image data onto the display device 11 (Step 4).

In Step 1, a user can switch the portable device 1 to the image capture mode, so that the image capture device 12 can capture a plurality of external image data.

In Step 2, the user can use the image capture device 12 to capture the plurality of image data such as pictures and save the image data in the memory device 13.

In Step 3, the user presses the slide show key 14 to produce a browsing triggering signal to the image capture device 12 and get ready for browsing the image data.

In Step 4, the controller 15 executes the program to display the plurality of image data stored in the memory device 13 onto the display device 11, wherein the program plays the captured image data in sequence or in random to facilitate the user to browse the captured image. In this step, when the controller 15 executes the program to play the image data, the user also can use the image capture device 12 to continue capturing the image data. The program will add the new captured image data in the playing sequence and show the captured image on the display device 11. Now, the sub-screen of the display device 11 will show the screen (not shown in the figure) of a shot captured by the image capture device 12, and the other sub-screen shows the image data stored in the memory device 13, so that the user can capture and browse the picture simultaneously without the need of switching the operating mode of the portable device 1.

Further, the method of the present invention further comprises a step of the controller 15 carrying out the program to play the image data while playing a selected music as background music (Step 5). The user can select a built-in music of the portable device 1 as background music/song. If the user browses the image, the controller 15 executes the program to play the image data, the background music/song can be outputted by the sound output device 17.

Further, the method of the present invention comprises a step of the controller 15 continuing checking whether or not the slide show key 14 is released (Step 6). If the slide show key 14 is released, then the portable device 1 of the invention terminates the browsing of the image data, and if the slide show key 14 is not released, then the procedure returns to Steps 4 and 5 to continue browsing image data.

With the present invention, the image data captured by the image capture device 12 can be displayed simultaneously on the display device 11 without the need of switching the operating mode. Therefore, the present invention surely can overcome the shortcomings of the prior art portable having the function of an image capture device.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

What is claimed is:

1. A method for capturing and browsing image data synchronously, comprising the steps of:
providing a portable device, and said portable device comprising an image capture device, a display screen, and a controller;
said portable device under an image capture mode using said image capture device to capture a plurality of image data and saving said plurality of image data into said portable device;
said controller receiving a browsing triggering signal; and
said browsing triggering signal triggering said controller to execute a program, and said program plays said plurality of image data in sequence on said display screen.

2. The method for capturing and browsing image data synchronously of claim 1, further comprising the step of said controller executing said program while said image data is played, and also playing a selected music as background music.

3. The method for capturing and browsing image data synchronously of claim 1, wherein said display device is a liquid crystal display device and further comprises a divisible picture-in-picture screen.

4. The method for capturing and browsing image data synchronously of claim 3, wherein said controller execute said program to play said plurality of image data in sequence on said display screen, and when said controller executes said program to play said image data, a user can use said image capture device to continue capturing said image data, and said program adds a new captured image data to the playing sequence and display said new captured image data on a picture-in-picture screen of said display device.

5. The method for capturing and browsing image data synchronously of claim 1, wherein said portable device is a digital camera.

6. The method for capturing and browsing image data synchronously of claim 1, wherein said image capture device is a CCD image capture module, a CMOS image capture module, or a digital camera module.

7. The method for capturing and browsing image data synchronously of claim 1, wherein said portable device further comprises a memory slot coupled to said controller for inserting at least one memory card.

8. The method for continuously browsing image data by an image capture device of claim 7, wherein said memory card is a SmartMedia, a CompactFlash, a MMC, a Security Digital(SD), a Memory Stick, a Memory Stick Pro, a Xd or a Microdrive memory card.

9. The method for capturing and browsing image data synchronously of claim 1, wherein said program is capable of playing said image data according to the sequence of capturing said image data or playing said image data in random in the step of said controller executing said program to play said plurality of image data in sequence on said display screen,

10. The method for capturing and browsing image data synchronously of claim 1, wherein said browsing triggering signal further comprising the step of setting the number of times for browsing said image data or terminating said browsing by a user.
